(19) United States
(12) Patent Application Publication
(10) Pub. No.: US 2017/0116639 A1
(43) Pub. Date: Apr. 27, 2017

(54) FORMATTING WEB PAGES WITH ADVERTISEMENTS

(71) Applicant: Tomasz J. Tunguz-Zawislak, San Francisco, CA (US)

(72) Inventor: Tomasz J. Tunguz-Zawislak, San Francisco, CA (US)

(73) Assignee: Google Inc., Mountain View, CA (US)

(21) Appl. No.: 11/939,889

(22) Filed: Nov. 14, 2007

(51) Int. Cl. G06Q 30/00; G06F 3/14; G06Q 30/02

(52) U.S. Cl. CPC G06Q 30/0256

(57) ABSTRACT

General instructions for the appearance of media that include advertisements are identified, a specific medium is identified, and the specific medium is displayed according to the identified instructions.

In one aspect, a selection of a set of generic instructions for the appearance of web pages are received, an indication of the selection is communicated, the selected set of generic instructions are received, and in response to receiving a request to view a web page, a representation of the web page with an appearance determined according to the received instructions is transmitted.

### TECHNICAL FIELD

This disclosure relates to information management.

### BACKGROUND

Web pages on the Internet frequently include advertisements. In some cases, stylistic elements of the advertisements, such as font faces, sizes, and colors, are specified when the ad is requested from an ad server. Custom settings for a given web page publisher may be stored at the ad server and applied to ads for that publisher automatically.

Skin files allow a user or developer to control the appearance of electronic interface elements, such as web pages and application programs, by supplying a set of formatting instructions and graphical elements, such as font and image files, that can be used to supplement or replace default elements used to format the interface when a skin is not applied.

### SUMMARY

In general, in one aspect, general instructions for the appearance of media that include advertisements are identified; a specific medium is identified; and the specific medium is displayed according to the identified instructions.

Implementations may include none, one or more of the following features. The medium can include one or more of a web page, a video, or a printed document. The general instructions can include identifications of one or more of fonts, colors, and images. The instructions can include instructions for the appearance of an area of a medium extending beyond an area provided for the advertisements. The area is the entire medium. Identifying the general instructions can include identifying general instructions associated with a specific advertisement. Identifying a specific medium can include identifying a specific advertisement and identifying a specific medium on which the specific advertisement will be displayed. Bids can be received from advertisers to have the identified general instructions be general instructions corresponding to the respective advertisers, and identifying the general instructions can include selecting a winning bid. A price can be received from a publisher of the identified medium, an offer can be received from an advertiser, and identifying the general instructions can include determining that the offer satisfies the price. The general instructions can include instructions to give media an appearance consistent with an advertising campaign. Identifying the general instructions can include receiving an identification from a publisher of the medium of a specific set of general instructions. After a set of general instructions for the appearance of web pages is received, it can be determined that the set of general instructions comply with a rule, and the general instructions can be stored. Identifying the general instructions can include receiving from a publisher of the specific medium an identification of the received set of general instructions.

In general, in another aspect, general instructions are identified for the appearance of any content that includes one or more particular sponsored content items, specific content is identified, and the specific content is presented according to the identified instructions. In some implementations, the specific content can include content for a printed publication or a web page and the sponsored content items can include advertisements.

In general, in another aspect, for each of several potential elements of a web page on which an identified advertisement is to appear, where the elements include parts of the web page other than the advertisement, a set of parameters for attributes is received, the parameters being associated with the identified advertisement. Identifications are stored of each potential element for which a set of parameters is received and of the received parameters.

Implementations may include none, one or more of the following features. The attributes may include one or more of fonts, colors, and images. The potential elements of the web page may include one or more of text, backgrounds, advertisements, and empty space. The elements for which the parameters are received may include advertisements and an area of the web page extending beyond an area provided for the advertisements.

In general, in one aspect, a selection of a set of generic instructions for the appearance of parts web pages other than advertisements are received, the selected set of instructions being associated with a specific advertisement. The selected set of generic instructions are received, and in response to receiving a request to view a web page, a representation of the web page with an appearance determined according to the received generic instructions and including the specific advertisement is transmitted.

Implementations may include none, one or more of the following features. Transmitting the representation of the web page can include identifying, within code defining the web page, at least one indication of an element of the web page to which the instructions can be applied. Indications can be identified, within the set of instructions, of attributes corresponding to the identified indication. The appearance of the identified elements of the web page can be determined according to the indicated attributes. Receiving the selection of the set of general instructions can include receiving an identification of the specific advertisement.

These and other aspects and features, and combinations of them, may be expressed as methods, apparatus, systems, means for performing functions, program products, and in other ways. Other features and advantages of the invention will be apparent from the description and the claims.

### DESCRIPTION OF DRAWINGS

FIG. 1 shows an example system for delivering advertisements to web browsers.

FIGS. 2A and 2B show example web pages.

FIG. 3 shows an example process by which a skin may be applied to a website.

FIGS. 4A to 4C show flow diagrams of processes for using skin files to control appearances of web pages.

FIG. 5 shows an example process by which a repository of skins may be maintained.

FIG. 6 shows a schematic diagram of a generic computer system.

### DETAILED DESCRIPTION

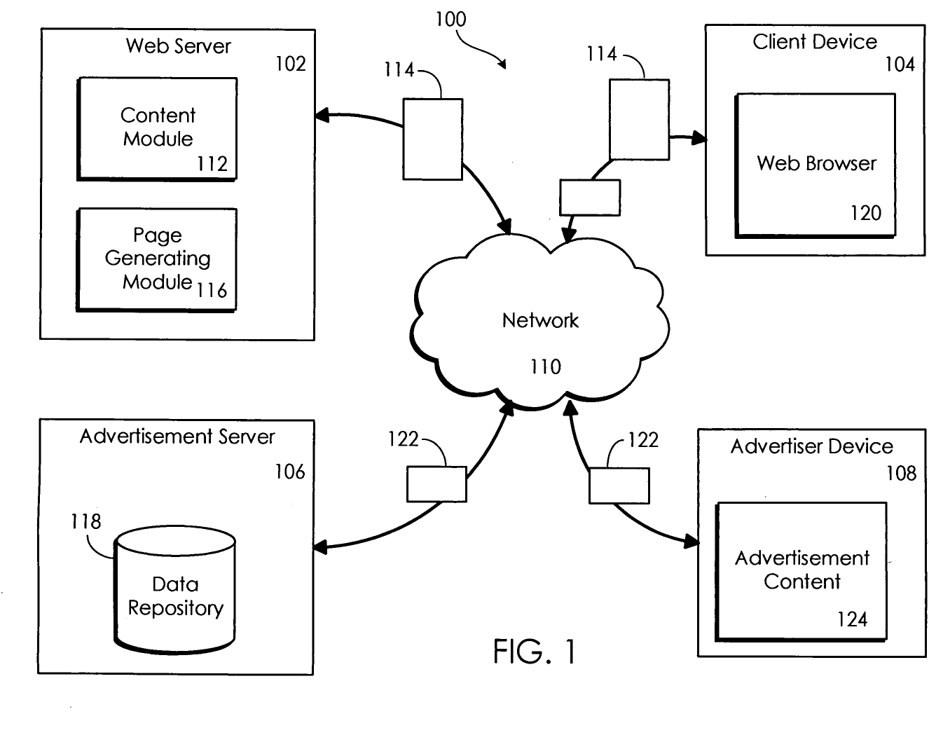

FIG. 1 shows an example of a system 100 for delivering advertisements (“ads”) to web browsers. Though reference is made to delivery of advertisements, system 100 can deliver other forms of content including other forms of sponsored content. The system 100 includes a web server 102, a client device 104, an advertisement server 106, an advertiser device 108, and a network 110. In some examples, the web server 102 provides web pages to the client device 104, in which the web pages include ads provided by the ad server 106. The web server 102, client device 104, and the ad server 106 are configured to enable control of the appearance of the advertisements by, for example, authors or publishers of the web pages, advertisers who own the ads, or users who view the ads. The appearances of the web pages maybe controlled by using, for example, skin files. Though reference is made to the control of the appearance of web pages, system 100 can be used to control the appearance of other forms of media (e.g., a printed publication, a video a multimedia presentation, etc.).

In the example of FIG. 1, the web server 102 contains a content module 112 and a web page generating module 116. The content module 112 provides the content of a web page 114 to be displayed. The content of the web page 114 can contain a forum thread, a conversation, a discussion, a news article, or some other content, to name just a few examples. The page generating module 116 creates the web page 114 containing the content provided by the content module 112. The page generating module 116 can also request advertisements 122 from the advertisement server 106 to be displayed on the web page 114. In some examples, the advertisements 122 are sent from the advertisement server 106 to the web server 102 and then forwarded to the client device 104. The advertisements 122 can be sent to the client device 104 already integrated into a web page 114 or they can be sent independently. In some examples, the advertisements 122 are sent directly to the client device 104 from the advertisement server 106.

The advertisements 122 are derived from advertisement content 124 (e.g., created by an advertiser) and are provided to the advertisement server 106 by the advertiser device 108. Alternatively, the system 100 or a third party can provide the advertisement content 124. The advertisements 122 may be stored in a data repository 118 at the advertisement server 106 or they may be provided on-demand directly from the advertiser device 108, which may itself be an advertisement server. In some examples, the advertisements 122 are generated on-demand by the advertisement server based on general instructions rather than specific content provided by the advertiser. For example, an advertisement may be generated directing a user to a current auction listing for a product a user entered as input in a search engine.

The client device 104 includes a web browser program 120. The web browser 120 can, among other things, display the web page 114 retrieved from the web server 102 through the network 110. The web page 114 can be requested by the user device 104 or the web server 102 may provide it without a request from the user device 104. The web browser 120 may also display the advertisements 122 if they are delivered without having first been integrated into the web page 114. In some examples, the web browser 120 may integrate the advertisements 122 into the web page 114 itself. Alternatively, or in addition, the web browser 120 may display the advertisements separately from the web page 114.

The web server 102, client device 104, advertisement server 106, and advertiser server 108, in the example of FIG. 1, are connected to each other by the network 110. The network 110 can, for example, be a local area network (LAN), a wide area network (WAN), the Internet, any other type of network, or any combination of types of networks. In some examples, one or more of the servers 102 and 106 and devices 104 and 108 may be integrated, for example, the advertisement server 106 and the web server 102 may be integrated into a single server, or the advertiser server 106 and the advertiser device 108 may be integrated into a single device.

When advertisements are presented on web pages, one or more parties may desire to control the appearance of both the advertisements and the web page in general. The advertiser or other parties may desire to change the overall appearance of the web page in connection with advertisements displayed on it.

The parties who may desire to control the appearance of web pages include the author or publisher of the web page, the advertiser, and the user who is ultimately viewing the web page. The author or publisher may want to assure that advertisements placed on his web page are consistent in appearance with the content and appearance of the page—this may include selecting a font face, text size and color, and background images and colors that match or complement those of the web page. The advertiser may want to assure that the appearance of the advertisement is consistent with their brand identity, for example, Coca-Cola may want an advertisement for Coke® to have white text on a red background using the same font as is used on their cans and bottles. The advertiser may want to extend their brand identity to other areas of the web page. Continuing the Coca-Cola example, Coca-Cola may want to change the background of the entire web page to red. A user may want to configure ads to use a combination of font size and color other than the default, for example, larger fonts in a high-contrast color scheme to accommodate limited vision.

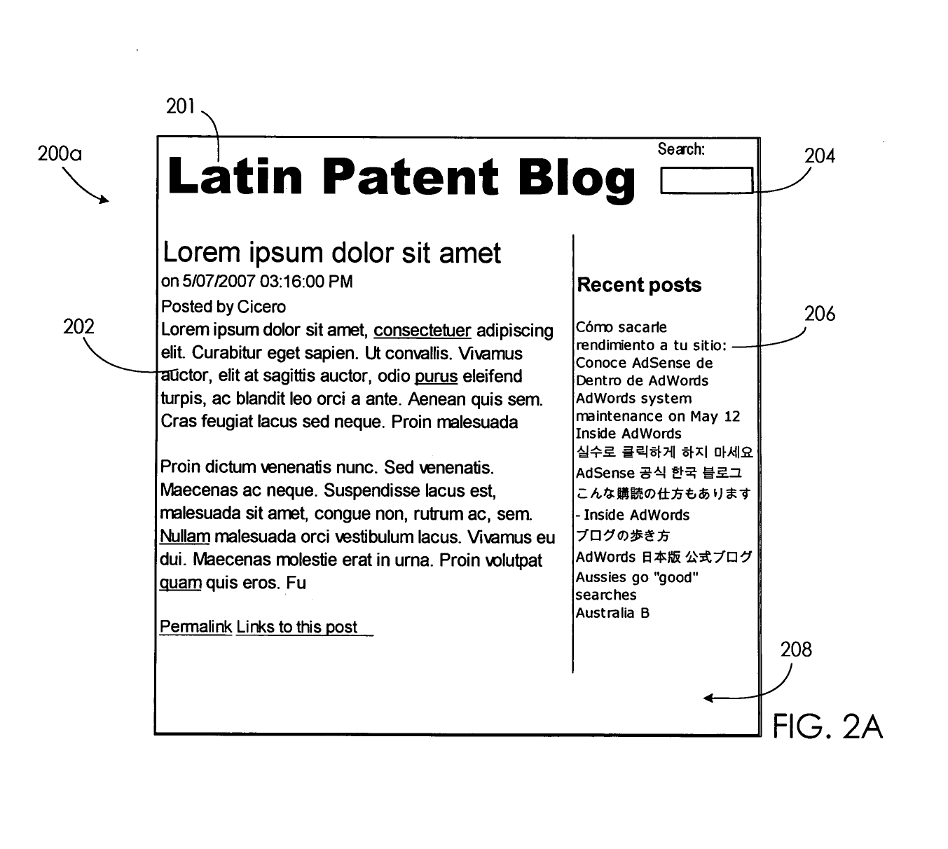

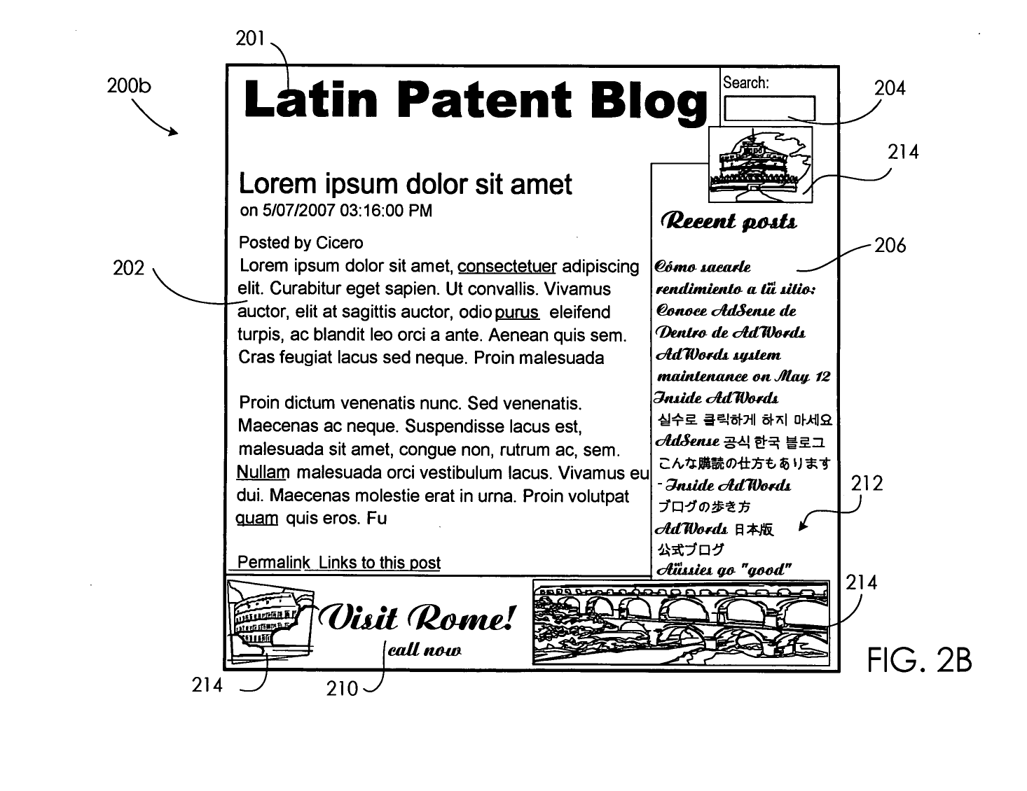

FIGS. 2A and 2B show example web pages 200a and 200b, respectively. Web page 200a is shown in an unformatted state, and FIG. 200b is the same web page with a “skin” applied. Websites may contain a number of visual elements other than their primary content 202, such as their title 201, menus or input boxes 204, lists 206 of links, and unused space 208, commonly called “white space,” though its actual color may vary. As part of an advertising campaign, an advertiser may want to change all the white space 208 near its ads 210 to the same background color 212 as its ads, or change the peripheral content, such as side links 206, to use a font face and color that match the advertiser's brand identity. The advertiser may also want to include background images 214 separate from its ads 210. We refer to this as “skinning” the web site. A skin, as the term is used herein, refers to a formatting definition that defines a set of appearance criteria for content included in a web page, such as fonts, colors, and background images, and any related files such as font files and image files needed to carry out the formatting. The formatting definition may be a Cascading Style Sheet (CSS) file or another style sheet-based formatting definition. Though we refer to a “skin file,” the skin may be a single file or a collection of files. The skin may include formatting definitions for content in a web page beyond a particular advertisement that is associated with the skin. A skin may also include executable code, such as animations, morphing, and mouse-over actions.

Web site publishers may offer the opportunity to skin their sites to advertisers through the ad vendor with whom they already work to place the advertisements. In some examples, the ad vendor's usual algorithm may be used to determine whether an advertisement for a participating vendor is delivered in the first place, and if it is, the skin is applied to the web page. For example, an airline may want to place ads on blogs when they discuss air travel, and to style the entire page when they do so, but not to style the page or deliver their ads if the blogs are discussing pet food. The ad vendor uses a variety of algorithms to identify what the blog is discussing and deliver appropriate ads. When the algorithms determine that an ad for an airline is appropriate and the participating advertiser is the one to use, the advertiser's skin is applied together with the ad.

The availability of skins that extend beyond the boundaries of advertisements represents an additional source of revenue to web sites beyond that brought in by advertisements alone. A web publisher may specify a minimum amount of compensation he would require to apply a skin to his web page (e.g., a flat rate, a cost-per-thousand-impressions (CPM), or some other arrangement). Advertisers may specify specific web sites or types of websites they want to skin, which may be a narrower set than the websites on which they want their ads placed, and what price they will pay for the skins to be used. Advertisers may bid on the right to have their skins used when their ads are placed on a web page, as part of or in addition to the existing process by which they may bid or pay for placing the ads in the first place.

The availability of skins may also factor in direct negotiations. For example, an advertiser may contact a web publisher and offer to pay some amount for that publisher to use the advertiser's skin for an entire week, independently of whatever arrangement the publisher may already have for advertisements. Skins may make this arrangement more appealing to the web publisher because he will not have to modify the code underlying his website to apply a skin provided by the advertiser.

In some implementations, an API allows advertisers or other users to create skin packages that may include font styles and sizes, colors, borders, backgrounds, images, and other design elements. The API provides standardized ways to identify what to use for each item a designer wants to control. The API may also provide standardized ways for web page authors to identify the components of their web pages so that skins can be applied. It may also allow authors to specify that some elements may be skinned and other elements should always use the design chosen by the author. Similarly, the API may provide ways for advertisers to indicate how skins should be applied to their advertisements, independently of the skins themselves (e.g., so that a user-supplied skin will be correctly applied to an ad when the advertiser's own skin is not used).

A skin package may specify details for as many potentially skinnable elements of a web page as the skin designer wants. When the skin is applied, whichever elements that the publisher of a particular web site includes or chooses to allow to be skinned are formatted according to the skin. In this way, a skin may specify the appearance for an entire web page, but if the publisher of the page only wants the area around the ads to be skinned, only that portion of the skin is used. Such a balance may interrelate to the bidding process described above. For example, a publisher who will only use a portion of a skin may receive less compensation than one who allows the whole skin to be used, or an advertiser may only use skins on web pages that will use the entire skin.

In addition to advertisers providing skins as described above, web publishers or users may provide their own skins. For example, a publisher of a website about a particular movie may use a skin designed by a fan of the movie to format the page, in which case the skin may be disconnected from (i.e., not associated with) any advertisements. For example, a user-supplied skin may be used to format the page whenever an advertisement does not have its own skin associated with it. The ad vendor may maintain a library of skins that publishers may choose from, or publishers may be able to provide their own skins—stored locally or uploaded to the ad vendor's servers, as described below. Users may also specify skins, either selected from the ad vendor's or a third party's libraries or provided by the users themselves. Users might use a skin to style their personal web pages on social networking sites, on pages they design themselves or on pages they view from other sources, if no skins are already used on such pages.

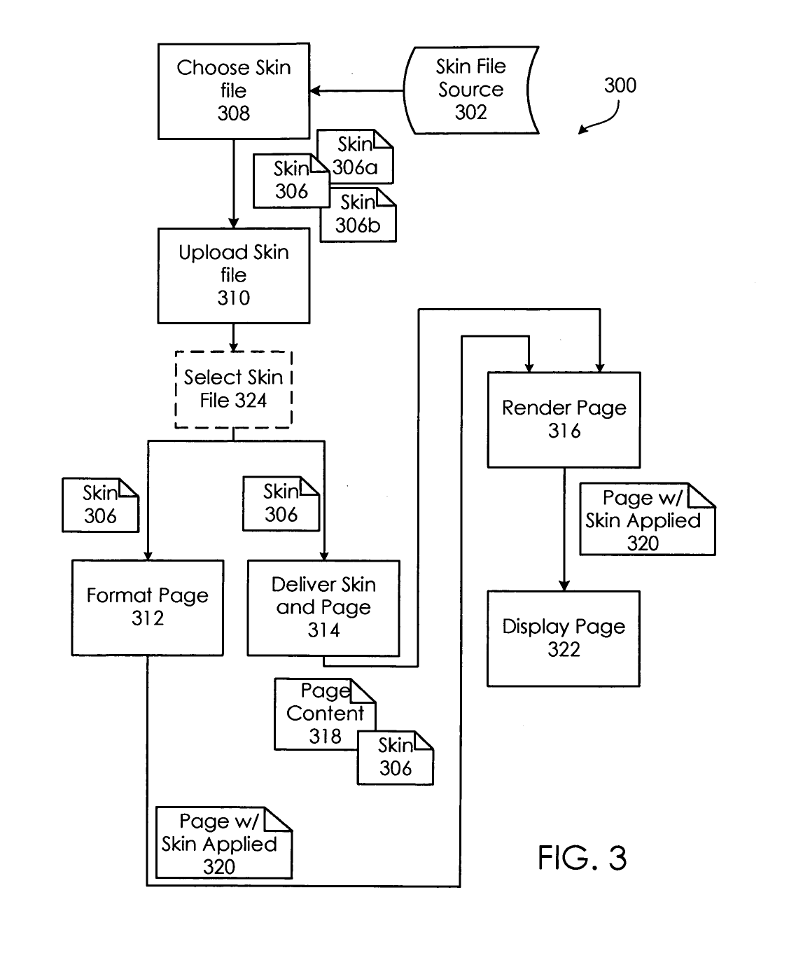

FIG. 3 shows an example process 300 by which a skin may be applied to a website. Skin files are taken from a source 302 that may be the data repository 118 (FIG. 1) or any other file server or data source. The data flows for skin files 306 are shown along side the steps of the flow chart for the process 300. In the example of FIG. 3, the developer, advertiser, or user first chooses 308 the skin file 306 she wishes to use (possibly after creating it) and uploads 310 it to a server. An advertiser may specify more than one skin file 306a, 306b to be used in different situations, as described below. A developer may upload the skin file 306 to her own server, or she may upload it to a third party server such as the advertisement server 106 (FIG. 1), as might an advertiser. A user might keep the skin file 306 on her own computer, or might also upload it to a third-party server, for example, so that it can be applied to websites rendered on any computer that users uses, assuming the user logs in or in some other way identifies herself so that such preferences can be applied.

In some examples, skin files 306 are already maintained on the advertisement server 106 and the advertiser, developer, or user only has to select one (step 324). When rendering 316 the web page, the selected skin file 306 is used to determine how the page is rendered 316. This may be done by formatting 312 the page before delivering the skinned version 320 to the user's web browser 120 (FIG. 1) or it may be done by delivering 314 both an unformatted page 114 (FIG. 1) and the skin file 306 to the client device 104. The skinned page 320 is then displayed 322 on the web browser 120. In the example of advertiser-selected skins, the step of choosing a skin 308 may have two parts—choosing the skin file 306 by the advertiser (step 308), and determining that the skin file 306 should be applied (step 324), carried out by, for example, the advertisement server. As above, these and the other steps in the process 300 may be combined and may be performed in an order other than that shown.

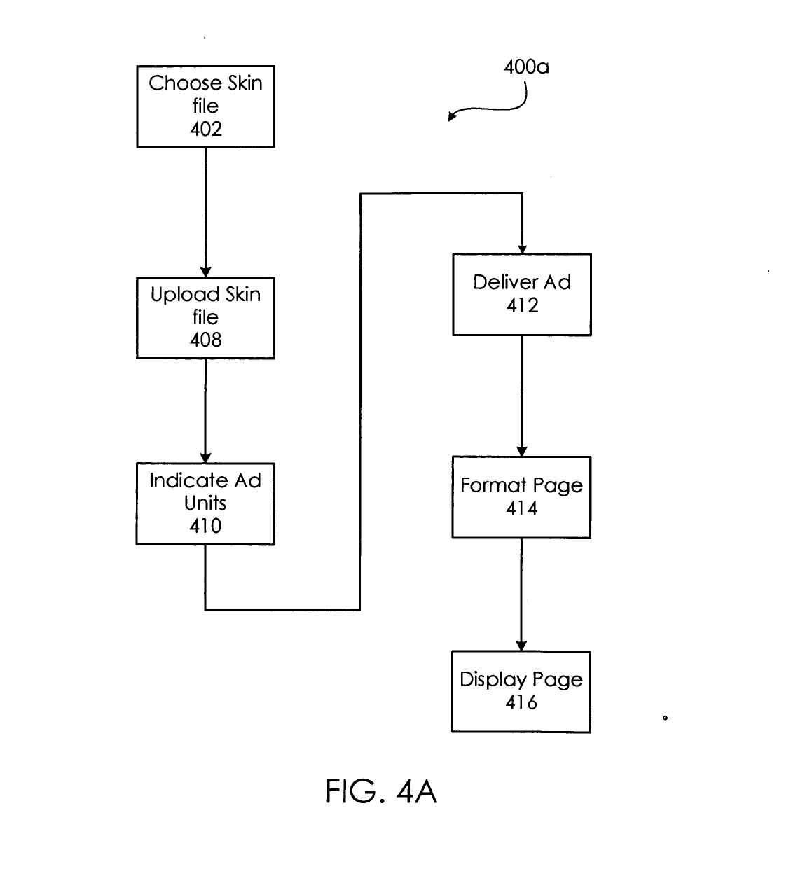

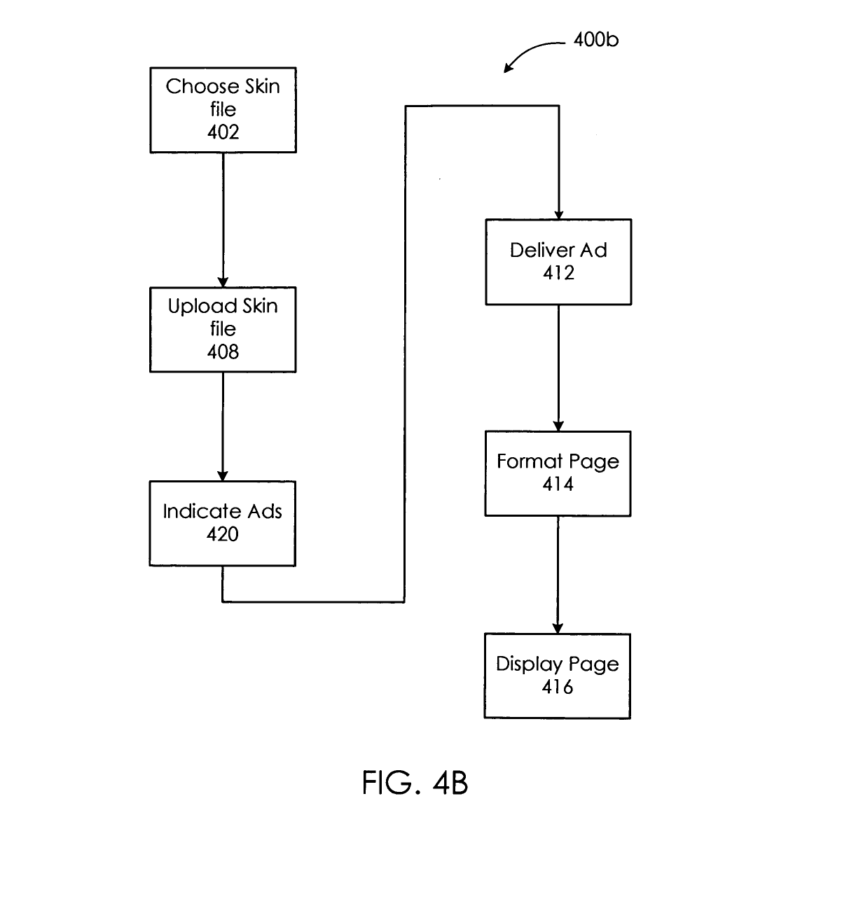

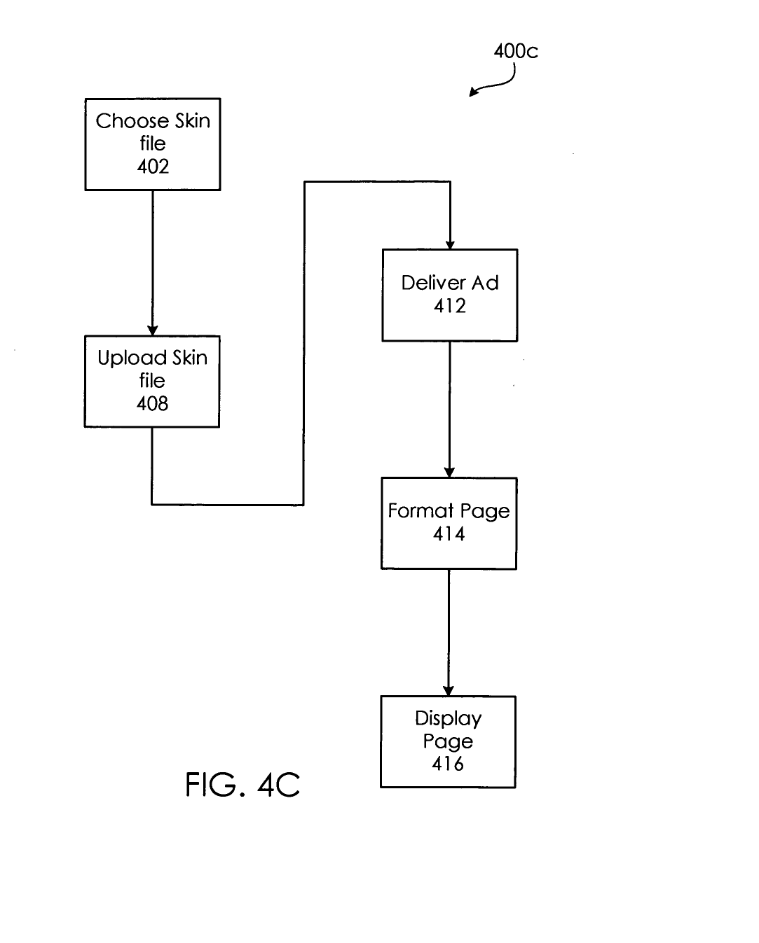

In some examples, skin files are provided using the processes shown in one or more of FIGS. 4A, 4B, and 4C. FIG. 4A shows an example of a process 400a by which a publisher of a web site may select a skin file to control the appearance of web pages. In this example, the skin file 306 (FIG. 3) is chosen 402 by the publisher of the web site from the skin files available from the skin file source 302 (which may be the publisher's own server). The publisher may create the skin file himself or he may obtain it from some third-party source (e.g., a fan of the website or a professional graphic artist). If the publisher created the skin file 306, he may upload it 408 to a server to share with others, for example, he may upload the skin file 306 to the advertisement server 106. The publisher next indicates 410 which ad locations on his web site should trigger application of the skin file 204. Whenever the advertisement server 106 (FIG. 1) delivers 412 ad content 124 for use in the specified ad unit (for example, to the web server 102 or directly to the client device 104), the page 114 is formatted 414 according to the formatting instructions in the chosen skin file 306. The formatted page 320 is then displayed 416 by the web browser 120.

If the web server 102 has direct access to the skin file 306, it may perform the formatting 414 itself, and the steps of uploading 408 the skin file 204 and specifying 410 its use may be skipped (or effectively performed internally). Uploading 408 the skin file 306 may also be skipped if the skin file 306 is already stored at the advertisement server 106, for example, if it was supplied by the advertiser. Depending on the implementation, various steps of the process 400a may be performed in a different order or combined into single actions.

In some examples, the publisher may store the skin file locally, e.g., on the web server 102 with the content of the web page, and specify where the skin file may be found when indicating 410 which ad units to use it with. This may be done, for example, by transmitting a URL of the skin file to the advertisement server 106, putting the URL in an agreed-upon location, such as in a text file similar to the robots.txt file used by web sites to control search engine indexing, or by putting the skin file itself in an agreed-upon location.

FIG. 4B shows an example of a process 400b by which an advertiser may control the appearance of a web page that includes the advertiser's advertisement. In this example, the skin file 306 is chosen 402 by the advertiser. The advertiser creates or obtains the skin file 306 and uploads it 408, for example, to the advertisement server 106. The advertiser may indicate 420 which of the advertiser's ads the skin file 306 should be used with, for example, by specifying specific ads or one or more properties, such as key words, that would cause an ad to be delivered. For example, a retail store might provide a skin file 306a that skins an entire web page, and specify that that skin file 306a should be used to format ads delivered to web sites that have existing styles that conflict with the advertiser's brand identity, while another skin file 306b that skins only white space around the ad is used for ads delivered to web sites that have neutral styles.

The server 106 may provide the skin file 306 by directly sending the file when it delivers 412 the ad or by indicating its location on a server available to the web server 102 or to the client device 104. The skin file 306 may be provided to the web server 102 to apply to the web page 114 before transmitting the HTML describing the web page 114 to the viewer, or it may be provided directly to the user's web browser to be applied when the page is rendered 316.

FIG. 4C shows an example of a process 400c by which a user may control the appearance of pages using the same system that associates skins with advertisements used by web site publishers or advertisers. In this example, the skin file 306 is chosen 402 by the viewer of the web page. If the viewer has an account with the ad vendor, he may upload 408 the skin file 306 to the advertisement server 106 or another server maintained by the ad vendor where information pertinent to the viewer's account is maintained. When the advertisement server 106 delivers 412 an ad to that viewer, it may deliver 412 the ad content 124 and skin file 306 for handling by the web browser 120. Similarly to the process 400a in FIG. 4A, the viewer may also specify a location of the skin file 306 or place it in a given location and configure his browser 120 to apply the skin file 306 whenever an ad is placed on a web page 114, or at any other time the user prefers.

If more than one of the above examples is implemented, such that more than one party my attempt to control the appearance of web pages, various policies may be implemented to determine which party's preferences control. For example, an advertiser may be given priority over a user's selection in order to maintain the consistency of the advertiser's branding. To implement the above examples, web pages are configured to make use of the skin files and to respect the formatting they indicate. This can be accomplished by including HTML commands to use skin formatting in the text defining the web page content 124. Various formatting systems can be used, such as CSS files, Document Style Semantics and Specification Language (DSSSL), Extensible Stylesheet Language (XSL), other style sheet languages, and other standards for specifying formatting or a proprietary standard developed by the ad vendor or a third party.

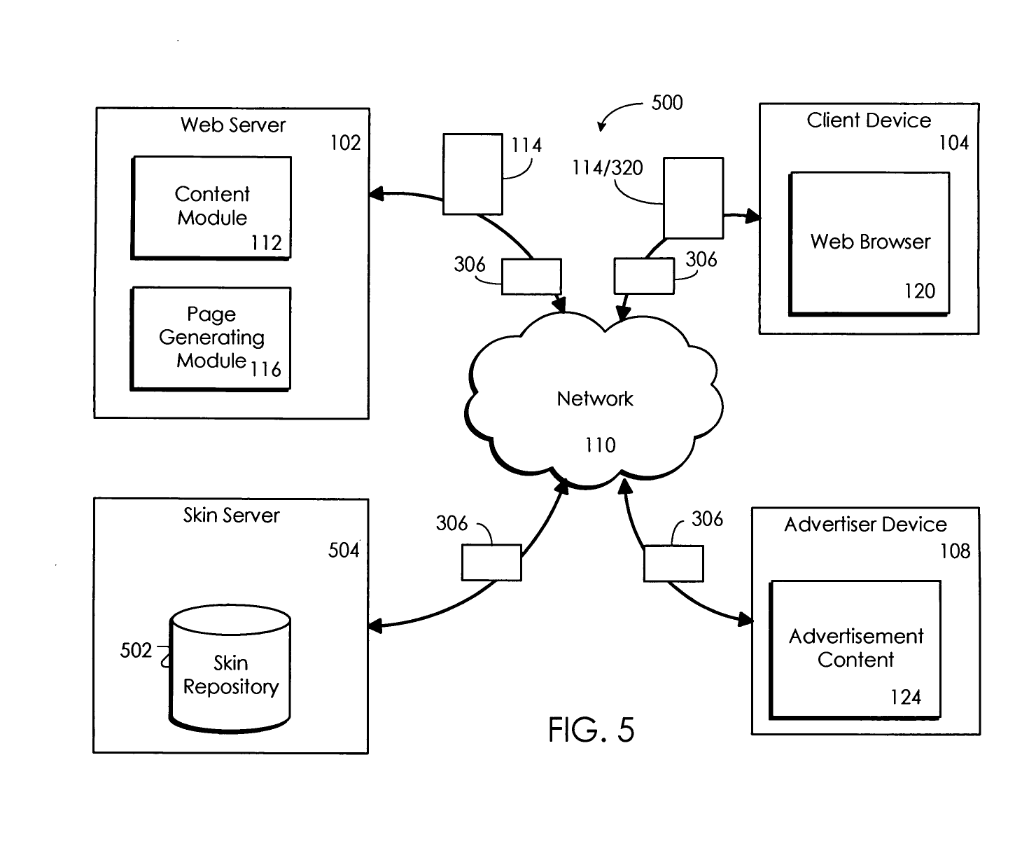

FIG. 5 shows an example of a system 500 with which a repository 502 of skin files 306 may be maintained. The web server 102, client device 104, and advertiser device 108 may be the same as in FIG. 1. To make skin files available, the ad vendor or another party operating a skin server 504 maintains the skin repository 502. As discussed above, any of a web developer (operating the web server 102), a user, or an advertiser may upload a skin file 306 to the skin server 504, where it is stored in the skin repository 502. The operator of the skin server 504 may examine the skin file 306 to make sure it complies with any rules or guidelines. Depending on the policies of the operator of the skin server 504 and the preferences of the party that uploaded each given skin file 306, skin files may be made available to any party or to a limited subset of parties. When a skin file is needed, it is transferred from the skin server 504, through the network 110, to the web server or directly to the client device. For example, the web page 114 may be formatted according to the skin file 306 at the web server 102 and delivered to the client device as an already formatted page 320 or the web page 114 and skin file 306 may be delivered independently to be assembled by the web browser 120.

In some examples, the skin repository 502 may function as a database used to store and access the skin files 306. Such a database may use a combination of unique identifiers and descriptive tags to allow potential users to find skin files directly or by searching based on their content. Operating the skin server 504 may involve reviewing skin files as they are submitted to make sure they comply with the API and with any other standards (e.g., for content or style) that the skin server 504 operator may wish to apply. In some examples, a skin file may be available for a potential user to view but not available for use on a web page until it has been reviewed and approved. The status of any review may be an element of data associated with the skin in the database.

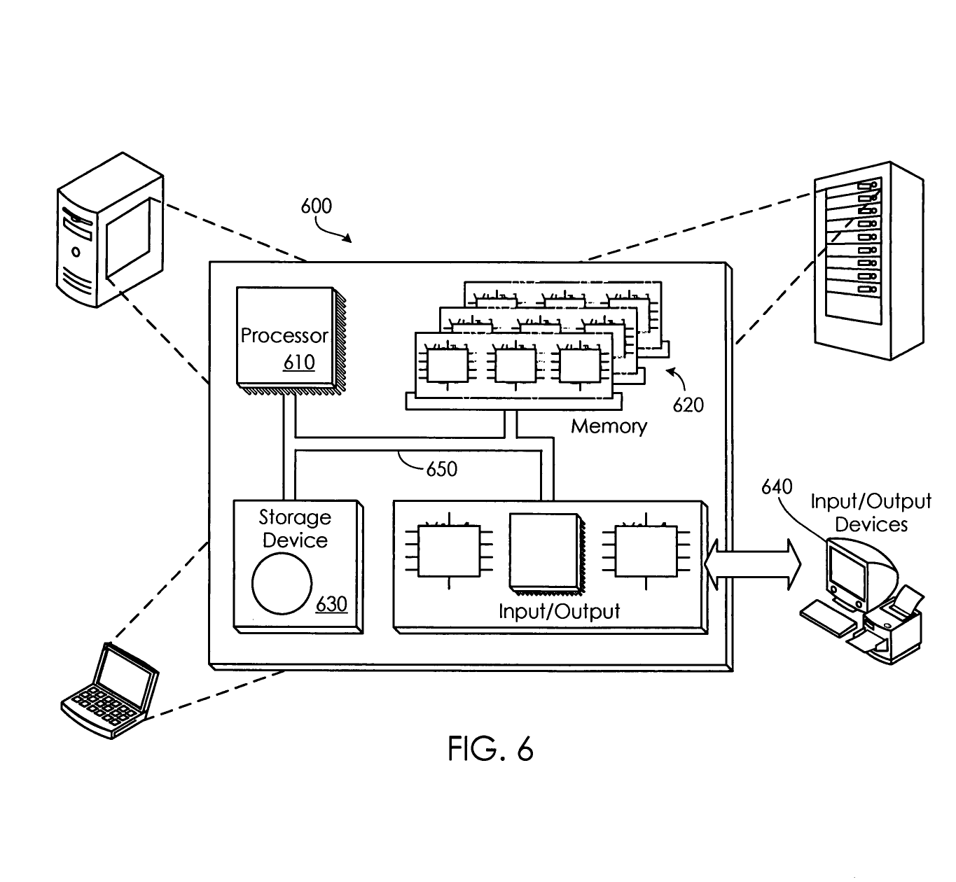

FIG. 6 is a schematic diagram of an example of a generic computer system 600 that can be used to implement, e.g., the web server 102, the client device 104, or the advertisement server 106. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The computing system 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document. The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A computer-implemented method, comprising:
identifying, by a server device, a web page that is to be published by a publisher;
identifying, by a server device, advertising content from an advertiser, the advertising content to be included in a particular portion of the web page;
identifying, by a server device, one or more skins distinct from the advertising content, the one or more skins including formatting definitions that are to (i) replace default formatting definitions for one or more visual elements included in one or more portions of the web page outside of the particular portion that includes the advertising content and (ii) be applied to one or more visual elements included in the advertising content;
determining that the publisher of the web page has specified that the one or more visual elements included in the one or more portions of the web page outside of the particular portion that includes the advertising content is to be formatted using the one or more skins;
determining that the advertiser has indicated that the one or more visual elements included in the advertising content are to be formatted using the one or more skins; and
formatting (i) the one or more visual elements included in the one or more portions of the web page outside of the particular portion that includes the advertising content, (ii) the one or more visual elements included in the advertising content in accordance with the formatting definitions of the one or more skins, wherein the one or more visual elements outside of the particular portion that includes the advertising content are formatted to be consistent in appearance with the one or more visual elements included in the advertising content by matching the one or more visual elements included in the advertising content and the one or more visual elements included in the one or more portions of the web page outside of the particular portion that includes the advertising content, wherein the one or more skins are associated with a specific portion of advertising content being presented in the publisher web content.

2. The method of claim 1, wherein identifying the one or more skins is based on a specification specifying a location of the advertising content to be displayed in a web page.

3. The method of claim 1, further comprising:
receiving the one or more skins from one or more skin providers; and
providing the one or more skins for sharing between the advertiser and the publisher.

4. The method of claim 3, further comprising:
providing to the one or more skin providers an application programming interface (API) for editing the one or more skins.

5. (canceled)

6. The method of claim 1, wherein formatting the one or more visual elements comprises transmitting, to the user device, formatting instructions that cause the user device to change at least one visual characteristic of the advertising content and to change at least one visual characteristic of the one or more portions of the web page outside of the particular portion that includes the advertising content.

7. The method of claim 1, wherein the one or more skins comprise an advertiser defined skin.

8. The method of claim 1, further comprising:
receiving bids from advertisers, each bid identifying an amount each advertiser will pay to have the one or more visual elements included in the one or more portions of the web page outside of the particular portion that includes the advertising content formatted based at least in part on an advertiser selected skin; and
identifying the one or more skins based at least in part on the bids.

9. The method of claim 8, wherein the one or more skins are associated with bids that satisfy a minimum amount of compensation specified by the publisher of the web page.

10. The method of claim 1, wherein the one or more skins comprises instructions to cause the one or more visual elements included in the one or more portions of the web page outside of the particular portion that includes the advertising content to be formatted based at least in part on elements of advertisements in an advertising campaign.

11. The method of claim 1, wherein the one or more skins comprise a skin specified by the publisher of the web page.

12. The method of claim 1, further comprising:
receiving a plurality of skins for formatting the web page;
determining whether each of the plurality of skins satisfy a rule specified by the publisher; and
storing the skins that satisfy the rule.

13. The method of claim 1, wherein the formatting instructions specifies a location from which the one or more skins can be retrieved.

14. (canceled)

15. A computer program product tangibly stored on a storage device and configured to cause one or more computing devices to perform operations comprising:
receiving, from a user device, a request for a web page that is to be published by a publisher;
identifying advertising content from an advertiser, the advertising content to be included in a particular portion of the web page;
identifying one or more skins distinct from the advertising content, the one or more skins including formatting definitions that are to (i) replace default formatting definitions for one or more visual elements included in one or more portions of the web page outside of the particular portion that includes the advertising content and (ii) be applied to one or more visual elements included in the advertising content;
determining that the publisher of the web page has specified that the one or more visual elements included in the one or more portions of the web page outside of the particular portion that includes the advertising content is to be formatted using the one or more skins;
determining that the advertiser has indicated that the one or more visual elements included in the advertising content are to be formatted using the one or more skins; and
formatting (i) the one or more visual elements included in the one or more portions of the web page outside of the particular portion that includes the advertising content, (ii) the one or more visual elements included in the advertising content in accordance with the formatting definitions of one or more skins in response to the request for web page, wherein the one or more visual elements outside of the particular portion that includes in the advertising content are formatted to be consistent in appearance with the one or more visual elements included in the advertising content by matching the one or more visual elements included in the advertising content and the one or more visual elements included in the one or more portions of the web page outside of the particular portion that includes the advertising content, wherein the one or more skins are associated with a specific portion of advertising content being presented in the publisher web content.

16. The product of claim 15, wherein identifying the one or more skins is based on a specification specifying a location of the advertising content to be displayed in the web page.

17. The product of claim 15, further comprising:
receiving the one or more skins from one or more skin providers; and
providing the one or more skins for sharing between the advertiser and the publisher.

18-21. (canceled)

22. A system, comprising:
one or more server devices configured to perform operations comprising:
identifying, by the one or more server devices, a web page that is to be published by a publisher;
identifying, by the one or more server devices, advertising content from an advertiser, the advertising content to be included in a particular portion of the web page;
identifying, by the one or more server devices, one or more skins distinct from the advertising content, the one or more skins including formatting definitions that are to (i) replace default formatting definitions for one or more visual elements included in one or more portions of the web page outside of the particular portion that includes the advertising content and (ii) be applied to one or more visual elements included in the advertising content;
determining that the publisher of the web page has specified that the one or more visual elements included in the one or more portions of the web page outside of the particular portion that includes the advertising content is to be formatted using the one or more skins;
determining that the advertiser has indicated that the one or more visual elements included in the advertising content are to be formatted using the one or more skins; and
in response to receiving a request to view the web page on which the advertising content will appear, formatting (i) the one or more visual elements included in the one or more portions of the web page outside of the particular portion that includes the advertising content (ii) the one or more visual elements included in the advertising content in accordance with the formatting definitions of the one or more skins, wherein the one or more visual elements outside of the particular portion that includes the advertising content are formatted to be consistent in appearance with the one or more visual elements included in the advertising content by matching the one or more visual elements included in the advertising content and the one or more visual elements included in the one or more portions of the web page outside of the particular portion that includes the advertising content, wherein the one or more skins are associated with a specific portion of advertising content being presented in the publisher web content.

23. The system of claim 22, wherein transmitting the code comprises:
identifying, within the code defining the web page, at least one indication of the one or more visual elements of the web page to which the formatting instructions can be applied;
identifying, within the formatting instructions, indications of attributes corresponding to the identified indication; and
determining an appearance of the one or more visual elements of the web page according to the indicated attributes.

24. The system of claim 22, wherein identifying the one or more skins is based on a specification specifying a location of the advertising content to be displayed in the web page.

25. The system of claim 22, further comprising:
receiving the one or more skins from one or more skin providers; and
providing the one or more skins for sharing between the advertiser and the publisher.

26. The method of claim 1, further comprising compensating the publisher based at least in part on the one or more visual elements included in the one or more portions of the web page that are formatted by the one or more skins.

27. The method of claim 1, wherein the one or more skins are prioritized based on a whether the advertiser, a user, or the publisher has requested formatting of the one or more visual elements included in the one or more portions of the web page in accordance with the formatting definitions of each of the one or more skins.

28. The method of claim 1, wherein the one or more visual elements included in the one or more portions of the web page that are formatted by the one or more skins comprises one or more of text, a menu box, an input box, a list of links, or a background color.

29. The method of claim 1, wherein the formatting definitions of the one or more skins comprises at least one of a font, a color, or a background image.

30. (canceled)
